(19) United States
(12) Patent Application Publication
(10) Pub. No.: US 2013/0278365 A9
(43) Pub. Date: Oct. 24, 2013

(54) MAGNETIC CLIMBING SYSTEM

(71) Applicants: Bastiaan GRAVENDEEL, Schiedam (NL); Edwin Roberto VAN DER HEIDE, Rijpwetering (NL)

(72) Inventors: Bastiaan GRAVENDEEL, Schiedam (NL); Edwin Roberto VAN DER HEIDE, Rijpwetering (NL)

(73) Assignees: TECHNISCH ADVIESBUREAU "EARLY MINUTE" B.V., Schiedam (NL); EYECATCHERS, Rijpwetering (NL)

(21) Appl. No.: 13/074,630

(22) Filed: Mar. 29, 2011

Related U.S. Application Data
(63) Continuation of application No. PCT/NL2009/000190, filed on Sep. 30, 2009.

(30) Foreign Application Priority Data
Sep. 30, 2008 (NL) 2002039

(51) Int. Cl. H01F 7/02; H01F 7/06

(52) U.S. Cl. 335/219

(57) ABSTRACT

A magnetic climbing system comprising a plurality of magnet units adapted to be attached to the body of a user or to a robot or robot platform is described. The magnet units each comprise a permanent magnet unit for generating an attractive force between the magnet unit and a ferrous or magnetic structure. The magnet units further comprise an electromagnet arranged to operate in a first and a second state thereby generating a different magnetic flux leaving the magnet unit (and thus required for generating the attractive force). As such, the magnetic climbing system as described enables the generation of larger attractive forces, compared to known climbing systems. As a consequence, the climbing system according to the present invention may pose less stringent conditions to the friction coefficient of the surface that is climbed. It also creates the possibility of ceiling walking.

### CROSS-REFERENCE TO RELATED APPLICATIONS

The present application is a National Stage entry under 35 U.S.C. § 371 of International Patent Application No. PCT/NL2009/000190, filed on Sep. 30, 2009, which claims priority of Dutch Patent Application No. NL2002039, filed on Sep. 30, 2008. The disclosures of PCT/NL2009/000190 and NL2002039 are hereby incorporated by reference in their entirety.

### BACKGROUND OF THE INVENTION

1. Field of the Invention

The present invention relates to a magnetic climbing system for climbing structures to which magnets develop an attracting force, such as ferrous or magnetic walls. The magnetic climbing system according to the invention can be applied for entertainment purposes but may equally be applied to facilitate manufacturing or inspection of large ferromagnetic structures such as tanks or ships.

An aspect of the invention is to provide a climbing system that overcomes or mitigates at least one of the drawbacks of known climbing systems.

2. Related Art

Magnetic climbing systems are e.g. known from U.S. Pat. No. 7,052,447 and comprise a number of magnet units (mountable to a hand or a leg), each magnet unit comprising one or more permanent magnets for generating an attractive force between the magnet units and a ferromagnetic structure. In order to climb a structure (e.g. a wall), the user of the climbing system (i.e. the climber) needs to release one or more of the magnet units from the structure and reposition them. In order to release the magnet unit, the user has to overcome the attractive force exerted by the magnet unit on the structure. When a comparatively large distance needs to be climbed, this may become a tiresome operation.

When releasing the magnet unit from the wall relies solely on overcoming the permanent magnet force by the climber, the strength of the climber limits the attractive force that may be exerted and thus the available holding force required for the climbing. Limiting the attractive force exerted by the magnet units may impose limitations to the application of the known magnetic climbing systems. In order for the climber not to slide down along the structure (e.g. a vertical wall), the frictional force between (less than all of) the magnet units and the wall needs to compensate the weight of the climber. The frictional force being proportional to the attractive force exerted on the wall, a limitation of the attractive force available may thus impose a limit to the friction force between the magnet unit and the wall. Based on the available force (e.g. the maximum permanent magnet force that can be overcome by the climber) and the weight of the climber, a minimal friction coefficient may be required. The requirement of such a minimum friction coefficient may limit the application of known climbing system as such a minimum friction coefficient may not be available with certainty.

As an alternative to the application of permanent magnet for the provision of the attractive force, the use of electromagnets for this purpose is disclosed in U.S. Pat. No. 3,031,778. The use of electromagnets for generating the required attractive force may however require an important power source for generating the current required by the electromagnets. It will also be acknowledged that the application of electromagnets for generating the attractive force (and thus the holding force that counteracts the weight of the climber) may pose a safety risk for the climber. In case of an interruption of the power supply, the attractive force of the electromagnets may be temporarily reduced or removed and the climber may fall.

### SUMMARY OF THE INVENTION

The invention meets the foregoing need and allows climbing surfaces with a lower coefficient of frictions using both permanent magnets and electromagnets, which results in a significant increase in efficiency and other advantages apparent from the discussion herein.

According to an aspect of the invention, there is provided a magnetic climbing system comprising a plurality of magnet units adapted to be attached to the body of a user, each magnet unit includes (1) a permanent magnet unit arranged to provide a magnetic flux through an end portion of the magnet unit for generating an attractive force between the magnet unit and a ferrous or magnetic structure; and (2) an electromagnet being operable in a first state, thereby having a first magnetic flux polarity and in a second state, thereby having a second magnetic flux polarity, the electromagnet further being arranged to support the magnetic flux being directed through the end portion when operating in the first state and to oppose the magnetic flux being directed through the end portion when operating in the second state thereby, in use, enabling the attractive force of the magnet unit to be modified, wherein the electromagnet is arranged to operate in the first state and the second state, respectively, by applying a current pulse to a coil of the electromagnet thereby magnetizing a magnetizable member of the electromagnet to generate a magnetic flux substantially having the first polarity and the second polarity, respectively, through the magnetizable member of the electromagnet.

The magnetic system according to the present invention comprises e.g. four magnet units, each magnet unit comprising a permanent magnet unit and an electromagnet. The magnet units are adapted to be worn by a user on the limbs of the user (e.g. two magnet units for the hands of the user and two magnet units for the feet or knees or lower legs of the user). Magnet units may alternatively, or additionally, be attached to the chest or back of the user. The magnetic climbing system according to the invention may also be adapted to be mounted to a robot or robot platform in order to enable the robot or robot platform to climb a ferrous or magnetic structure. The magnetic climbing system according to the invention may also be integrated with the robot or robot platform.

According to the invention, a permanent magnet unit may comprise one or more permanent magnets generating a magnetic flux.

Permanent magnets as can be applied in the present invention include but are not limited to ceramic or ferrite magnets, AINiCo magnets or rare earth magnets such as NdFeB magnets.

The permanent magnet units of the magnetic climbing system enable the generation of an attractive force between the magnet units and a ferrous or magnetic structure by, in use, generating a magnetic flux through an end portion of the magnet units when the end portion faces the ferrous or magnetic structure.

The magnet units as applied in the magnetic climbing system according to the invention may further comprise a ferromagnetic yoke for e.g. guiding, focusing or redirecting the magnetic flux originating from either the permanent magnets or the electromagnets.

The magnet units according to the invention further comprise an electromagnet. The electromagnet comprises a magnetizable member or core element for bringing the electromagnet in the first or second state. Magnetizing the electromagnet can be established by providing a current pulse to the electromagnet. Advantage is that only a small power is required to put the electromagnet in the first or second state. As a further advantage, during a power surge, the electromagnets of the magnet systems remain in the state they are in, thus not altering the magnetic holding force.

Electromagnets as applied in the present invention are operable in two different states (referred to as the first and second state) wherein the electromagnets have a different polarity (or orientation of the magnetic flux generated by the electromagnet). When operating in either one of the first or second state, the electromagnet is arranged to influence the path followed by the magnetic flux of the permanent magnet unit due to the different polarity in both states. As such, operating the electromagnet in either the first or second state may affect the magnetic flux that passes through an end portion of the magnet unit and thus enables the attractive force as provided by the magnet unit to be modified. When operating in the first state, the electromagnet is polarized in such manner that, in use, the magnetic flux of the permanent magnet is directed towards the end portion, i.e. the electromagnet supports the magnetic flux of the permanent magnet. When the electromagnet is operated in the second state, the magnetic flux of the electromagnet opposes the magnetic flux of the permanent magnet passing through the end portion. Rather, the magnetic flux of the permanent magnet is directed away from the end portion.

The climbing system according to the invention can e.g. be powered from a mains power supply and a converter. Such a converter can e.g. comprise a transformer and a rectifier for providing a DC power source for powering the electromagnets. As an alternative, the electromagnets can be powered from a battery or a battery pack.

The climbing system according to the invention provides magnet units of which the attractive force can be varied. As such, the climbing system according to the invention enables the application of a comparatively large attractive force (in order to hold the climber) when the electromagnets of the magnet units operate in the first state and a comparatively small (or zero) attractive force when the electromagnets of the magnet units operate in the second state, when a magnet unit needs to be displaced by the climber. As such, the magnetic force that can be generated in the first state (i.e. a comparatively large attractive force) need not be limited to a force that can be overcome by the climber. As such, in order to hold the climber (i.e. in order for the climber not to slide down), larger attractive forces (compared to known climbing systems) can be applied. As a consequence, the climbing system according to the present invention may pose less stringent conditions to the friction coefficient of the surface that is climbed.

The magnetic climbing system according to the invention may e.g. be applied for entertainment purposes. In this case, the magnetic climbing system may further comprise a ferrous or magnetic structure comprising one or more steel plates that can be climbed by the climber wearing the magnet units. The ferrous or magnetic structure may e.g. include steel plates that are in a substantially vertical position and plates forming a ceiling of the structures which can be in a substantially horizontal position.

The magnetic climbing system according to the invention can be applied to climb substantially flat surfaces but also concave or convex surfaces such as inner or outer surfaces of tanks or ships.

In an embodiment, the magnet units of the magnetic climbing system can be applied for mounting a platform (e.g. for supporting a person) to a ferrous or magnetic structure. The platform can e.g. be mounted to the structure via cables or other connections between the magnet units and the platform.

Additional features, advantages, and embodiments of the invention may be set forth or apparent from consideration of the following detailed description, drawings, and claims. Moreover, it is to be understood that both the foregoing summary of the invention and the following detailed description are exemplary and intended to provide further explanation without limiting the scope of the invention as claimed.

### BRIEF DESCRIPTION OF THE DRAWINGS

The accompanying drawings, which are included to provide a further understanding of the invention, are incorporated in and constitute a part of this specification, illustrate embodiments of the invention and together with the detailed description serve to explain the principles of the invention. No attempt is made to show structural details of the invention in more detail than may be necessary for a fundamental understanding of the invention and the various ways in which it may be practiced. In the drawings:

FIG. 1 schematically depicts two permanent magnets mounted to a magnetic structure.

FIG. 2 schematically depicts an electromagnet mounted to a magnetic structure.

FIGS. 3a, 3b, and 3c schematically depict a first embodiment of a magnet unit as can be applied in a climbing system according to the invention.

FIG. 4 schematically depicts a second embodiment of a magnet unit as can be applied in a climbing system according to the invention.

FIG. 5 schematically depicts a third embodiment of a magnet unit as can be applied in a climbing system according to the invention.

FIGS. 6a, 6b, and 6c schematically depict a fourth embodiment of a magnet unit as can be applied in a climbing system according to the invention.

FIG. 7 schematically depicts a power control circuit as can be applied in a magnetic climbing system according to the invention.

FIG. 8 schematically depicts another power control circuit as can be applied in a magnetic climbing system according to the invention.

FIG. 9a depicts a front view of an embodiment of a hand support unit of the climbing system according to the invention.

FIG. 9b depicts a front view of an embodiment of a foot support unit of the climbing system according to the invention.

FIG. 9c depicts a side view of the foot support unit of FIG. 9b.

FIG. 9d depicts a schematic side view of a hand support unit and a foot support unit attached to a magnetic structure, for illustrating foot support unit placement.

### DETAILED DESCRIPTION OF THE INVENTION

The embodiments of the invention and the various features and advantageous details thereof are explained more fully with reference to the non-limiting embodiments and examples that are described and/or illustrated in the accompanying drawings and detailed in the following description. It should be noted that the features illustrated in the drawings are not necessarily drawn to scale, and features of one embodiment may be employed with other embodiments as the skilled artisan would recognize, even if not explicitly stated herein. Descriptions of well-known components and processing techniques may be omitted so as to not unnecessarily obscure the embodiments of the invention. The examples used herein are intended merely to facilitate an understanding of ways in which the invention may be practiced and to further enable those of skill in the art to practice the embodiments of the invention. Accordingly, the examples and embodiments herein should not be construed as limiting the scope of the invention, which is defined solely by the appended claims and applicable law. Moreover, it is noted that like reference numerals represent similar parts throughout the several views of the drawings.

The present invention describes a climbing system for climbing ferrous or magnetic structures by means of magnet units comprising a permanent magnet unit and an electromagnet.

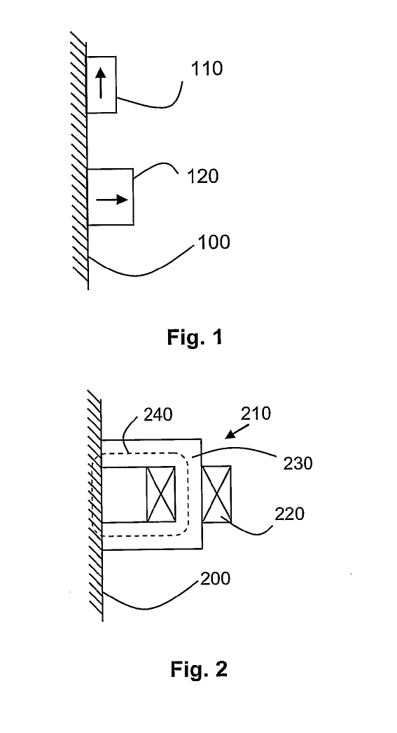

It is well known to use permanent magnets for mounting objects to a ferrous or magnetic structure. Within the meaning of the present invention, a ferrous or magnetic structure refers to a structure to which magnets (either permanent magnets or electromagnets) can be attracted. This is illustrated in FIG. 1. FIG. 1 schematically indicates a ferrous or magnetic structure 100 and two permanent magnets 110 and 120 mounted to the structure. The magnetic structure 100 (i.e. a structure to which permanent magnets or electromagnets can be attracted) provides a path of comparatively low magnetic resistance compared to the air surrounding the magnets and the structure. The permanent magnets 110, 120 can be attracted to the magnetic structure, irrespective of the polarization of the magnet.

In order to increase the magnetic attractive force, a ferromagnetic yoke (e.g. made from solid steel or laminated steel) can be provided. The ferromagnetic yoke enables an increase in the magnetic flux (as it reduces the magnetic resistance of the flux path) and enables the magnetic flux to be directed and focused.

Equally, electromagnets can be attracted to a magnetic structure when energized. FIG. 2 schematically depicts a magnetic structure 200 and an electromagnet 210. The electromagnet 210 comprises a coil 220 mounted to a ferromagnetic yoke 230. When a current is provided to the coil, a magnetic flux is generated which substantially follows a path 240, thereby generating an attractive force between the magnetic structure 200 and the electromagnet 210.

The present invention provides a climbing system comprising a plurality of, e.g. four magnet units to be worn by a user for climbing a ferrous or magnetic structure. Each magnet unit comprises a permanent magnet unit and an electromagnet for controlling an attractive force between the magnet unit and a magnetic structure.

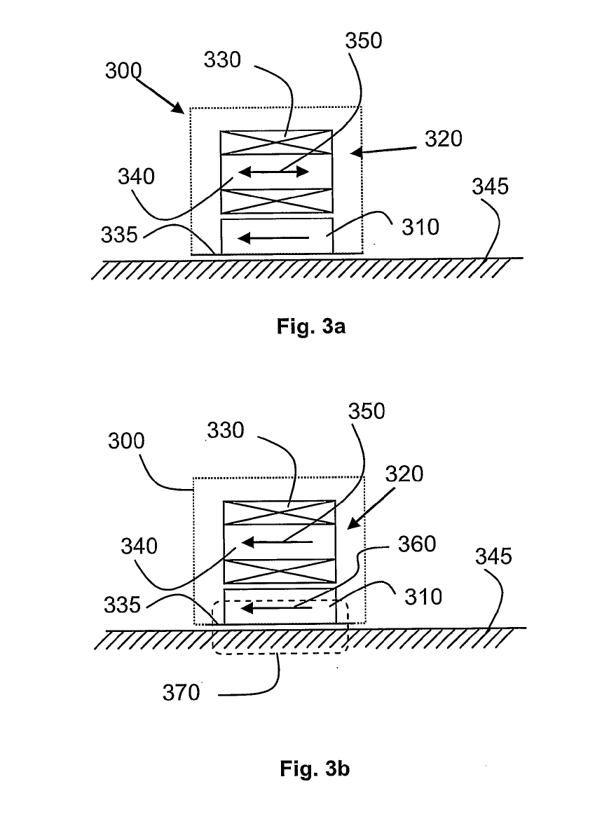

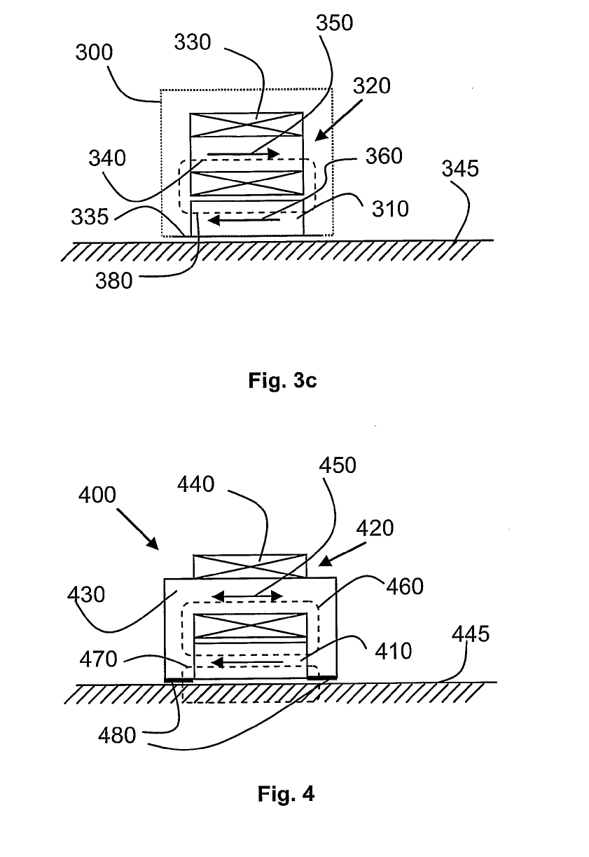

FIG. 3a schematically depicts a first embodiment of a magnet unit 300 as can be applied in the climbing system according to the invention. The magnet unit comprises a permanent magnet 310 and an electromagnet 320, the electromagnet 320 comprising a coil 330 and a magnetizable core element 340. In the embodiment as shown, the permanent magnet and the electromagnet can be arranged adjacent to each other and can be oriented such that the polarization of the permanent magnet (indicated by the arrow of the permanent magnet 310) is parallel to the magnetization of the electromagnet. The permanent magnet and the electromagnet can be arranged adjacent to each other in a direction substantially perpendicular to the end portion 335 of the magnet unit, the permanent magnet 310 being positioned near the end portion 335. The permanent magnet 310 provides in a magnetic flux which can pass through an end portion 335 of the magnet unit 300 in order to interact with a magnetic structure 345, thereby generating an attractive force. When a current is applied to the coil of the electromagnet 320, a magnetic flux is generated by the electromagnet, said magnetic flux having a polarity 350 depending on the orientation of the current that is applied. The permanent magnet 310 and electromagnet 320 of the magnet unit 300 are arranged in such manner that the amount of magnetic flux that passes through the end portion 335 of the magnet unit 300 depends on the polarization of the magnetic flux of the electromagnet 320. This can be illustrated as follows.

As indicated in FIG. 3b, when the polarization of the permanent magnet 310 and the electromagnet 320 are as indicated by the arrows 350 and 360, the magnetic flux of the electromagnet 320 is directed to support the magnetic flux of the permanent magnet 310 towards the end portion 335 thereby providing a comparatively large magnetic flux through the end portion and thus a comparatively large attractive force between the magnet unit 300 and the magnetic structure 345. In this situation, the magnetic flux of the permanent magnet may e.g. follow the path as indicated by 370.

When the electromagnet 320 is polarized as indicated in FIG. 3c, the polarization of the magnetic flux of the electromagnet 320 is such that the magnetic flux of the permanent magnet 310 is directed away from the end portion 335. Rather, the magnetic flux of the permanent magnet 310 will substantially flow along the path indicated by contour 380. As a result, a comparatively small magnetic flux will pass through the end portion 335 of the magnet unit 300, thus providing a comparatively small attractive force between the magnet unit 300 and the magnetic structure 345.

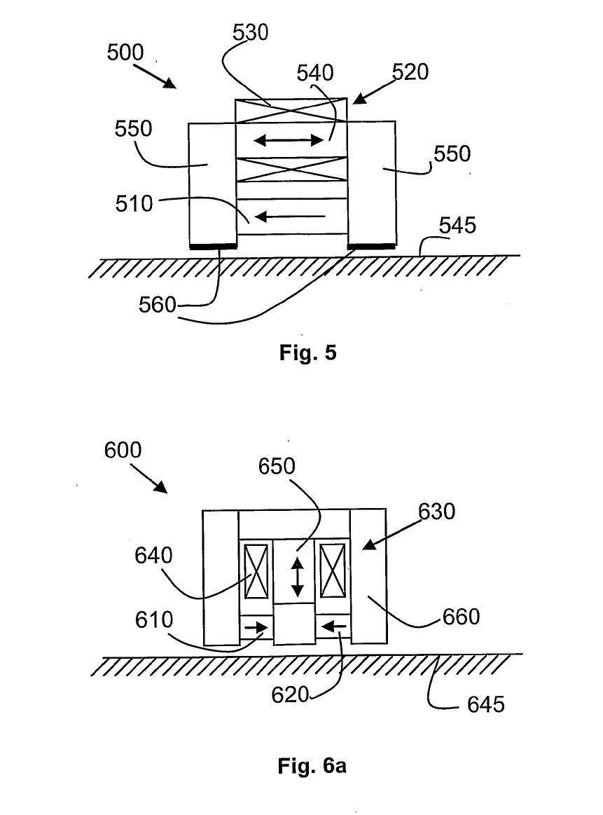

In order to increase the magnetic flux, a magnetizable yoke can be provided as e.g. indicated in FIG. 4. FIG. 4 schematically indicates a magnet unit 400 as can be applied in the climbing system according to the invention, the magnet unit 400 comprising a permanent magnet 410, an electromagnet 420 and a magnetizable yoke 430. The relative position of the permanent magnet 410 and the electromagnet 420 substantially corresponds to the position as shown in the embodiment of FIGS. 3a, 3b, and 3c. The electromagnet 420 comprises a coil 440 mounted to the magnetizable yoke 430. Depending on the magnetic polarization 450 of the electromagnet, the magnetic flux of the permanent magnet 410 will be inclined to flow along the path 460 (away from the magnetic structure 445) or the path 470 (substantially through the magnetic structure 445). The permanent magnet 410 can, as shown in FIG. 4, be arranged between the legs of the U-shaped magnetizable yoke 430. The permanent magnet 410 can be arranged near the end surfaces 480 of the magnetizable yoke 430, although the permanent magnet may also be positioned further inward (as e.g. shown in the embodiment of FIG. 5).

FIG. 5 schematically depicts a magnet unit 500 comprising a permanent magnet 510 and an electromagnet 520 comprising a coil 530 and a magnetizable member 540 enclosed by the coil 530. The magnet unit further comprises an optional ferromagnetic yoke 550. The ferromagnetic yoke 550 partly encloses the permanent magnet 510 and the electromagnet 520. When the ferromagnetic yoke 550 is applied, the permanent magnet may e.g. occupy the position of the electromagnet and vice versa. In the embodiment shown in FIG. 5, the ferromagnetic yoke 550 may comprise two substantially beam shaped members, extending in a direction substantially perpendicular to an end portion 560 of the magnet unit. The permanent magnet 510 and the electromagnet 520 can e.g. be arranged in between both members of the ferromagnetic yoke 550. The magnetizable member 540 of the electromagnet 520 enables the electromagnet 520 to produce a magnetic flux when the magnetizable member 540 is magnetized. This can be achieved by providing an electric current through the coil 530 for a comparatively short period of time, e.g. a current pulse, e.g. a current pulse of 100 ms. Once magnetized, a magnetic flux is generated by the magnetizable member 540 of the electromagnet 520. Depending on the polarization of the magnetic flux as generated by the electromagnet 520, the magnetic flux of the permanent magnet 510 can be directed substantially through the end portion 560 of the magnet unit 500 (to the magnetic structure 545) or away from the end portion 560. The polarization of the magnetizable member 540 depends on the orientation of the current that is applied in the coil 530 for the magnetization of the magnetizable member 540. By applying a current pulse with an opposite orientation, the magnetizable member 540 can be magnetized with an opposite polarity.

The embodiment as illustrated in FIG. 5 provides the advantage that the coil 530 of the electromagnet 520 does not need to be energized during the entire time that a magnetic flux is required. The electromagnet 520 with magnetizable member 540 can be enabled to generate a magnetic flux by applying a current pulse. Once magnetized, no current needs to be applied. As such, the energy requirements for the electromagnet can be reduced. Only comparatively short current pulses need to be provided to magnetize the magnetizable member 540 of the electromagnet 520 and thus generating a magnetic flux with a polarization to incite the magnetic flux of the permanent magnet 510 to pass through the end portion 560 or away from the end portion 560. As an example, the magnetizable member 540 can comprise an AINiCo alloy.

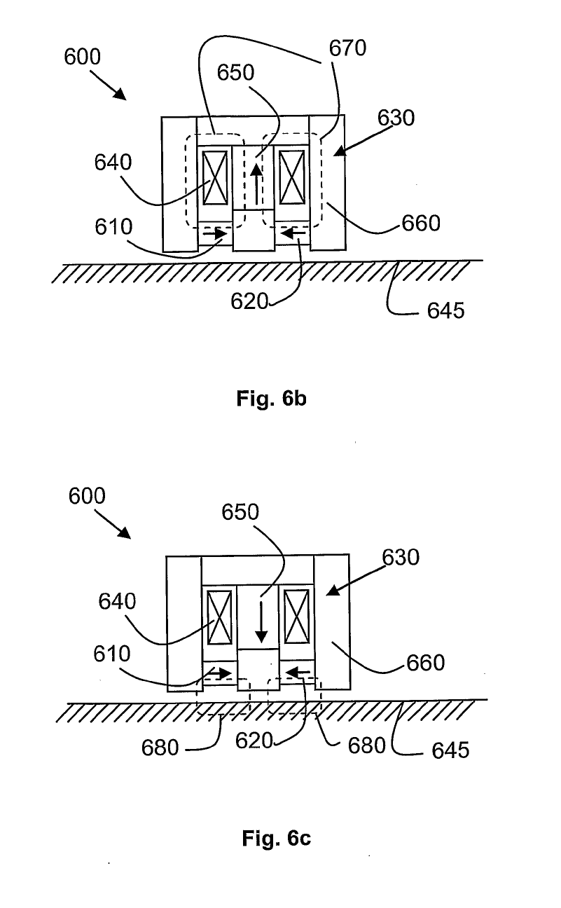

FIG. 6a schematically depicts another embodiment of a magnet unit as can be applied in a climbing system according to the invention. A magnet unit 600 comprises two permanent magnets 610, 620, an electromagnet 630 comprising a coil 640 and a magnetizable member 650. The magnet unit further comprises an optional ferromagnetic yoke 660 for conducting the magnetic flux generated by the permanent magnets and the electromagnet. In the embodiment as shown, the ferromagnetic yoke at least partly encloses the coil of the electromagnet 630. Such an arrangement may facilitate the generation of the magnetic flux required for magnetizing the magnetizable member 650 of the electromagnet 630. By applying a current pulse to the coil 640 of the electromagnet, the magnetizable member 650 can be magnetized either as indicated in FIG. 6b, or as indicated in FIG. 6c. Depending on the polarization of the magnetizable member 650 (indicated by the arrow indicated in the magnetizable member 650), the magnetic flux of the permanent magnets 610, 620 may substantially flow along the paths 670 resp. 680 as indicated in FIGS. 6b and 6c.

As indicated in FIG. 6b, when the magnetic flux substantially flows along the path 670, a comparatively small attractive force can be generated between the magnet unit 600 and a ferrous or magnetic structure 645 whereas, when the magnetic flux substantially follows along the path 680 as indicated in FIG. 6c, a comparatively large attractive force can be generated.

In order to climb a magnetic structure with the climbing system according to the invention, the magnet units can e.g. be arranged to be worn by a user (i.e. the climber). The magnet units can be arranged to be releasably attached to the hands and feet or knees or lower legs of the climber. The climbing system according to the invention may further comprise a power source (e.g. a battery or battery pack) for powering the electromagnets of the magnet units.

In an embodiment of the climbing system according to the invention, the climbing system comprises a control unit for controlling the electromagnets. The control unit may e.g. enable the selection of a particular magnet unit of the plurality of magnet units (e.g. by a user interface), and control the power source for appropriately powering the selected magnet unit.

To illustrate the operation of the control unit as applied in an embodiment of the invention, the magnet units are assumed to be attracted to a magnetic structure and operate in a first state thereby providing a comparatively large attractive force between the structure and the magnet units. In order to displace one of the magnet units, the climber may, via a user interface (e.g. a selector or switch) select one of the magnet units and provide a control signal to the control unit to control the power supply to provide a current or current pulse to the selected magnet unit in order to bring this magnet unit to the second state, thereby providing a comparatively small attractive force. The user may then move the selected magnet unit away from the structure and put it back to the structure, e.g. at a different location. The user may then bring the magnet unit back to the first state by appropriately powering the electromagnet of the selected magnet unit. Alternatively, the magnet unit may be brought back to the first state by a proximity switch of an inductive or mechanical type, the switch being operable upon approaching the magnetic structure, or contacting the magnetic structure. In an embodiment, the control unit is arranged to, in use, enable only one magnet unit to operate in the second state at the same time. So, when one of the magnet units is operating in the second state (thereby generating a comparatively small attractive force), the control unit can be arranged to overrule or disregard a user command or control signal (that can e.g. be provided via a user interface) for bringing a second magnet unit to operate in the second state. As such, when the magnetic climbing system comprises four magnet units, at least three of them will operate in the first state thereby generating a comparatively large attractive force. Such control provides a safe way of operating the magnetic climbing system. It further facilitates the dimensioning of the magnet units of the magnetic climbing system. In case the magnetic climbing system comprises four magnet units, the magnet units should be dimensioned such that the weight of the user can be supported by any combination of three magnet units of the magnetic climbing system.

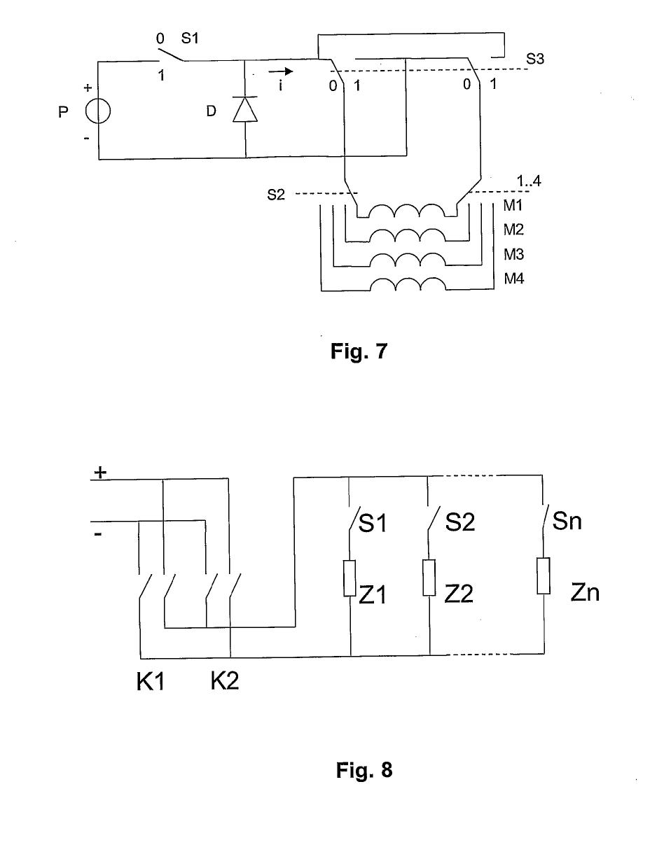

FIG. 7 schematically depicts a possible control circuit as can be applied for appropriately powering the electromagnets of the climbing system. The figure schematically depicts a power source P (e.g. a DC power supply such as a battery), a switch S1 for providing a current i (or current pulse) to the electromagnets. Four electromagnets are schematically depicted by the coils M1-M4. Schematically depicted by the switch S2 is a selector for selecting e.g. one of the coils M1-M4 and connecting the selected coil to the power source. FIG. 7 further shows a controllable switch S3 for providing a current in one of the two directions to bring the electromagnet in the first or the second state to the selected coil. In an embodiment of the present invention, the control of the various magnet units can be accomplished via a user interface which can be integrated or mounted to one or more of the magnet units (e.g. a magnet unit attachable to a hand of the user). The user interface can e.g. comprise a button (in general a selector) for selecting a magnet unit and a button for controlling the state of the selected magnet unit (operating the latter button a first time (after selection of the magnet unit) may change the magnet unit from operating in the first state to operating in the second state, operating the button a second time may change the operating state again to the first state). The control circuit as shown may further comprise a freewheeling diode D.

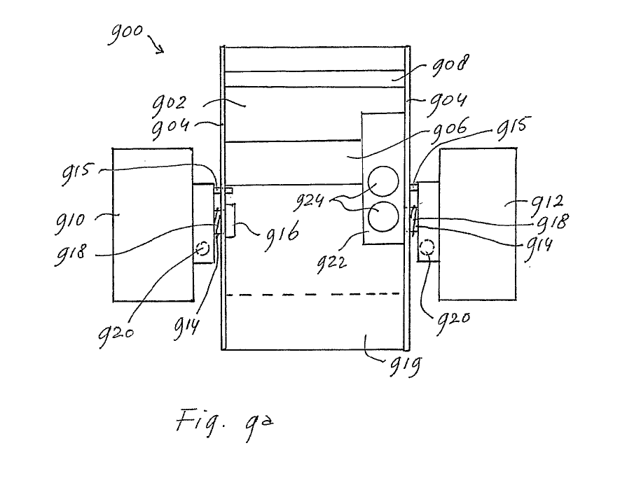

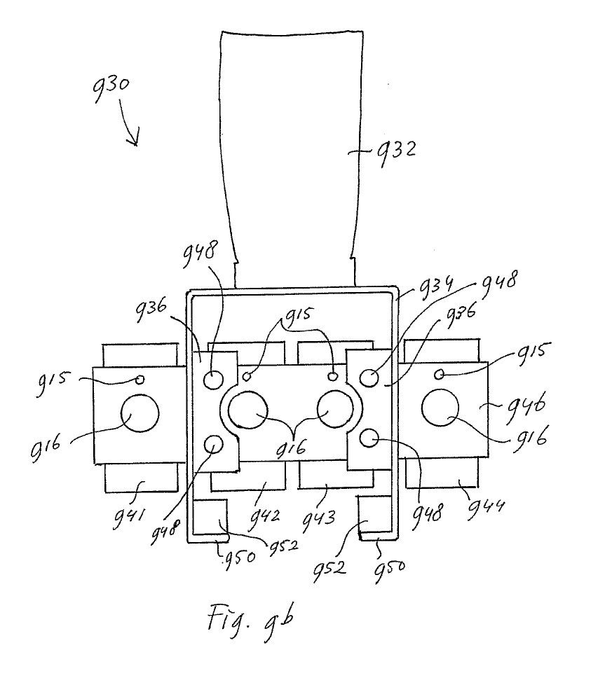

FIG. 8 depicts another possible power control circuit as can be applied for powering a plurality of electromagnets of the climbing system. Series arrangements of coils Z1-Zn of corresponding electromagnets and power switches S1-Sn are arranged in parallel between power supply lines of which the polarity can be made positive and negative by appropriate operation of switch K1 or switch K2. Switches K1 and K2 are in a toggle state: closing of switch K1 excludes closing of switch K2, and closing of switch K2 excludes closing of switch K1. Although not shown in FIG. 8, a safety arrangement may be included in the control circuit in that only one of the switches S1-Sn can be operated at the time, in particular for bringing an electromagnet from its first state (in which the electromagnet supports the magnetic flux generated by the corresponding permanent magnet in the same magnet unit) to its second state (in which the electromagnet opposes the magnetic flux generated by the corresponding permanent magnet in the same magnet unit). When K1 or K2 is closed, one of the switches S1-Sn can be operated to provide a current pulse to the coil connected in series therewith for changing the state of the electromagnet.

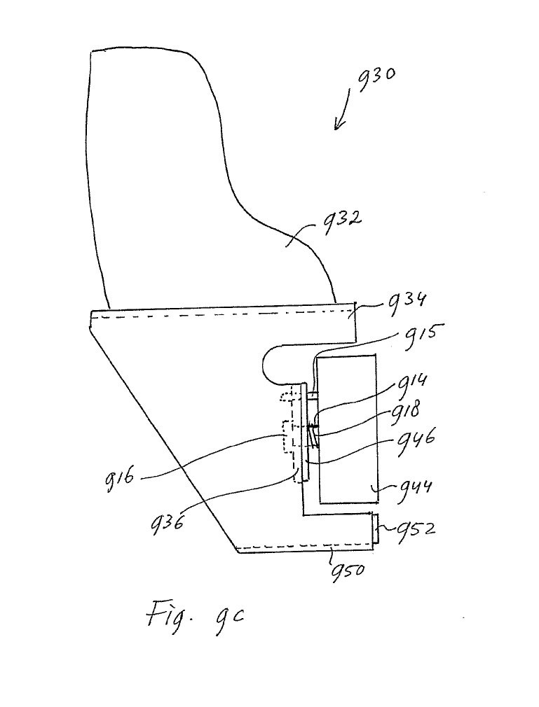

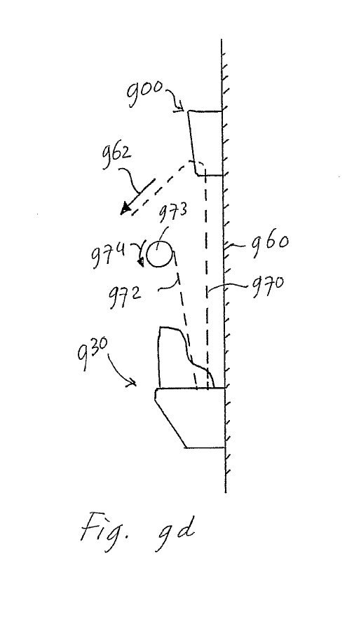

FIG. 9a depicts an embodiment of a hand support unit 900 for the climbing system. The hand support unit 900 comprises a hand gripping structure having a base plate 902 connected to two opposing flanges 904 defining ends of the hand gripping structure. The hand gripping structure has a handle 906 adapted to be gripped by a human hand. One or more rods 908 may be provided between the flanges 904 to reinforce the hand gripping structure, and to be able to connect other structures and elements, like ropes or karabiners, to the hand gripping structure. Also one or more holes may be provided in parts of the hand gripping structure for connecting other structures and elements. The hand support unit 900 comprises two magnet units 910, 912. Each magnet unit 910, 912 is connected to the hand gripping structure through a flexible member which will allow the magnet unit 910, 912 to slightly tilt and move with respect to the hand gripping structure in different directions. Thus, the flexible member provides the hand support unit 900 to be used on slightly uneven or curved surfaces of a ferrous or magnetic structure, and yet enable each magnet unit to firmly attach magnetically to the ferrous or magnetic structure by being able to align to the local surface. FIG. 9a illustrates a flexible member embodied as a pin 914 extending from a magnet unit 910, 912 through a hole in a corresponding flange 904. At its end facing away from the magnet unit 910, 912, the pin 914 has a stop 916 preventing the pin 914 to leave the hole. Between the magnet unit 910, 912 and the corresponding flange 904, a pressure spring 918 is provided. The hole in the flange 904 has a larger cross-section than the pin 914. A second pin 915 connected to each magnet unit 910, 912, and extending through a hole in the corresponding flange 904, prevents the magnet unit 910, 912 to rotate with respect to the flange 904.

Another example of a flexible member is a rubber element.

The base plate 902 of the hand gripping structure, which may be made from metal such as aluminum, may be provided with a material having a high friction coefficient at at least part of its side arranged to be facing a ferrous or magnetic structure, in particular the lower part 919 of its side arranged to be facing the ferrous or magnetic structure. In use, the base plate 902 will be pressed against the ferrous or magnetic structure by the magnetic force generated by the magnet units 910, 912, thus generating high friction forces parallel to the surface of the ferrous or magnetic structure.

Each magnet unit or the hand gripping structure may be provided with a proximity switch 920 arranged to provide a signal to bring the electromagnet of the magnet unit into its first state upon approaching or contacting the ferrous or magnetic structure.

The hand gripping structure comprises a user interface 922 having two pushbuttons 924 for bringing the electromagnets of the magnet units of a hand support unit 900 in their second state. The pushbuttons may be used to generate signals to be processed in a controller to activate one or more appropriate power switches to generate a current pulse for an electromagnet of a magnet unit.

In use, each hand support unit 900 may be connected to a belt or harness worn by a user of the climbing system through a rope or chain or similar flexible member.

FIGS. 9b and 9c depict an embodiment of a foot support unit 930 for the climbing system. The foot support unit 930 comprises a foot attachment structure having a foot or shoe support 932 and a generally U-shaped base plate 934 having two opposing flanges 936. The foot support unit 930 comprises four magnet units 941, 942, 943, 944. Like the magnet units 910, 912 of the hand support unit, each magnet unit 941, 942, 943, 944 is connected by a flexible member to the foot attachment structure. For this purpose, the foot attachment structure comprises a support plate 946 bolted to the flanges 936 by bolts 948. The magnet units 941, 942, 943, 944 each are connected in a flexible way to the support plate 946 by pins 914, 915 extending through corresponding holes in het support plate 946. The pins 914 each are provided with springs 918, and stops 916.

At the bottom of the base plate 934, flanges 950 are provided. The flanges 950 support strips 952 attached to the base plate 934, and at least partly made from a material having a high friction coefficient. As can be seen in FIG. 9c, end portions of the strips 952 will come into contact with a magnetic structure to which the foot support unit 930 will be placed, thus generating high friction forces parallel to the surface of the magnetic structure to prevent the foot support unit from slipping along the surface of the magnetic structure.

FIG. 9d illustrates a method of moving a foot support unit 930 along a (vertically oriented) magnetic structure 960. Taking into account that the foot support unit 930 has a relatively high mass, and thereby may be lifted or lowered only with considerable effort by a user (not shown) who would be able only to use his or her leg attached to the foot support unit 930 for this purpose, a lifting or lowering aid is provided.

A first embodiment of a lifting or lowering aid is a chain or rope 970, indicated with a dashed line. One end of the rope 970 is attached to the foot support unit 930, while the rope 970 is guided by a structure (like a ring or wheel) mounted on the hand support unit 900. With this arrangement, the rope 970 can be gripped by the hand of a user to assist the leg of the user in lifting (arrow 962) or lowering (opposite to arrow 962) the foot support unit 930 once it has been released from the magnetic structure 960. Alternatively, a rope 972 of which one end is attached to the foot support unit 930, may be engaged by a rope winding mechanism 973, e.g. a motor driven winder attached to a belt or harness of a user, to assist the leg of the user in lifting (arrow 974) or lowering (opposite to arrow 974) the foot support unit 930 disengaged from the magnetic structure 960.

A climbing process starts with a user taking two hand support units, each hand support unit for one hand, and two foot support units, each foot support unit for one foot. The electromagnets of the magnet units of the climbing system all are in a first state (without being electrically energized). The magnet units each are covered with a steel plate to ensure the magnetic field is shielded from the environment.

Then, in the user interface a button that corresponds with the magnet unit(s) to be deactivated (electromagnet in second state) is chosen, to start a climbing process. The steel plate covering the deactivated magnet unit(s) may be removed, and the magnet unit(s) concerned are ready for magnetic attachment to a magnetic structure.

An activation of said magnet unit(s) occurs when the proximity switch(es) controlling the magnet unit(s) change state.

In the operation of the user interface, the selection of the right side hand support unit or the right side foot support unit is on the left side user interface, and vice versa.

To start climbing the hand and foot support units are deactivated one by one by loosening the steel plates. Each support unit is attached to a wall (or another magnetic structure) that has to be climbed. After the support units are all connected to the wall, the user steps onto the foot support units and grasps the hand support units. Then the user deactivates one support unit and places it higher to climb upwards. When the deactivated support unit is placed close to the wall again the magnet unit(s) thereof activate(s). Then another support unit may be deactivated and may be moved to a proper location on the wall. By deactivating and activating each support unit, the user goes his way upwards.

A magnetic climbing system comprising a plurality of magnet units adapted to be attached to the body of a user is described. The magnet units each comprise a permanent magnet unit for generating an attractive force between the magnet unit and a ferrous or magnetic structure. The magnet units further comprise an electromagnet arranged to operate in a first and a second state thereby generating a different magnetic flux leaving the magnet unit (and thus required for generating the attractive force). As such, the magnetic climbing system as describes enables the generation of larger attractive forces, compared to known climbing systems. When applied for entertainment purposes, the climbing system according to the invention may be applied for climbing substantially vertical ferrous or magnetic structures but may equally allow the user to displace along a ceiling of a ferrous or magnetic structure. As a consequence of the larger attractive forces, the climbing system according to the present invention may pose less stringent conditions to the friction coefficient of the surface that is climbed. As in general, larger attractive forces can be generated compared to known magnetic climbing systems, the magnetic climbing system according to the invention may advantageously be applied to facilitate manufacturing or inspection of large ferromagnetic structures such as tanks or ships. The magnetic climbing system according to the invention allows the user to take along tooling (such as inspection tools) when climbing a ferrous or magnetic structure such as a tank or a ship.

While the invention has been described in terms of exemplary embodiments, those skilled in the art will recognize that the invention can be practiced with modifications in the spirit and scope of the appended claims. These examples given above are merely illustrative and are not meant to be an exhaustive list of all possible designs, embodiments, applications or modifications of the invention.

1. A magnetic climbing system comprising a plurality of magnet units configured to be attached to the body of a user, each magnet unit comprising:
a permanent magnet unit arranged to provide a magnetic flux through an end portion of the magnet unit to generate an attractive force between the magnet unit and a ferrous or magnetic structure; and
an electromagnet being operable in a first state, thereby having a first magnetic flux polarity and in a second state, thereby having a second magnetic flux polarity, the electromagnet further being arranged to support the magnetic flux being directed through the end portion when operating in the first state and to oppose the magnetic flux being directed through the end portion when operating in the second state thereby, in use, enabling the attractive force of the magnet unit to be modified, wherein the electromagnet is arranged to operate in the first state and the second state, respectively, by applying a current pulse to a coil of the electromagnet thereby magnetizing a magnetizable member of the electromagnet to generate a magnetic flux substantially having the first polarity and the second polarity, respectively, through the magnetizable member of the electromagnet.

2. The magnetic climbing system according to claim 1, wherein the magnetizable member of the electromagnet comprises AINiCo.

3. The magnetic climbing system according to claim 1, further comprising a power supply for providing a current to the electromagnet to, in use, enable a transition from operating the electromagnet in the first state to operating the electromagnet in a second state.

4. The magnetic climbing system according to claim 1, wherein the first polarity of the electromagnet is opposite to the second polarity of the electromagnet.

5. The magnetic climbing system according to claim 1, further comprising a control unit for controlling the electromagnet of the magnet units, and a user interface for providing a control signal to the control unit.

6. The magnetic climbing system according to claim 5 wherein the user interface enables the selection of a magnet unit of the plurality of magnet units.

7. The magnetic climbing system according to claim 5 wherein the user interface comprises an operating element for operating at least one electromagnet of a magnet unit by hand from the first state to the second state thereof, or reversely.

8. The magnetic climbing system according to claim 1, comprising a hand support unit comprising a hand gripping structure connected to at least one magnet unit.

9. The magnetic climbing system according to claim 8, wherein the hand gripping structure has two opposite ends, each end being connected to a magnet unit through a flexible member.

10. The magnetic climbing system according to claim 8, wherein the hand gripping structure comprises a surface arranged to engage the ferrous or magnetic structure, the surface comprising a material having a high friction coefficient, in particular a rubber material.

11. The magnetic climbing system according to claim 1, comprising a foot attachment structure connected to at least one magnet unit.

12. The magnetic climbing system according to claim 11, wherein the foot attachment structure has a support plate, a plurality of magnet units being connected to the support plate through a flexible member.

13. The magnetic climbing system according to claim 1, wherein the magnet unit comprises a proximity switch for operating the electromagnet to the first state thereof.
